(19) United States
(12) Patent Application Publication
(10) Pub. No.: US 2017/0283596 A1
(43) Pub. Date: Oct. 5, 2017

(54) SUPPORT MATERIAL, SUPPORT MATERIAL POWDER, AND METHOD FOR PRODUCING THREE-DIMENSIONAL OBJECT USING SAME

(71) Applicant: CANON KABUSHIKI KAISHA, Tokyo (JP)

(72) Inventors: Tomohiro Saito, Utsunomiya-shi (JP); Akira Sugiyama, Yokohama-shi (JP); Yukio Hanyu, Isehara-shi (JP); Naotake Sato, Sagamihara-shi (JP); Masahiko Takahashi, Kawasaki-shi (JP)

(21) Appl. No.: 15/471,929

(22) Filed: Mar. 28, 2017

(30) Foreign Application Priority Data
Mar. 31, 2016 (JP) 2016-072982
Mar. 2, 2017 (JP) 2017-039655

(51) Int. Cl. C08L 1/28; B33Y 70/00; B33Y 10/00; B33Y 50/02; C08K 7/02; B29C 67/00

(52) U.S. Cl. CPC C08L 1/286; C08K 7/02; B29C 67/0074; B29C 67/0092; B29C 67/0088; B33Y 10/00; B33Y 50/02; B33Y 70/00; C08L 2205/025; C08L 2205/16; C08K 2201/003; B29K 2201/00

(57) ABSTRACT

A support material contains at least one member selected from the group consisting of low molecular weight saccharides, polyvinyl alcohols, and polyalkylene glycols; non-water-soluble cellulose fibers; and a water-soluble cellulose derivative.

### BACKGROUND

### Technical Field

The present disclosure relates to a support material, support material powder, and a method for producing a three-dimensional object using the same.

### Description of the Related Art

In recent years, additive manufacturing including forming successive layers of shaping materials based on cross-sectional data (slice data) of a three-dimensional object to be produced (shaping target) has drawn attention as a method for producing a three-dimensional object.

When a three-dimensional object of a complicated shape having an overhang structure, a structure having a movable portion, or the like is produced by the additive manufacturing, a structure portion forming the three-dimensional object is sometimes formed on a region where an another structure portion is not present. In such a case, a support portion supporting the structure portion is provided on a lower side in the gravity direction of the structure portion. More specifically, the support portion is formed as necessary in a portion serving as a hollow of the three-dimensional object in a shaping process by the additive manufacturing. The support portion is finally removed.

Japanese Patent Laid-Open No. 2012-111226 describes a method for producing a three-dimensional object using a model material (structural material) which is a material forming the structure portion and a support material which is a material forming the support portion. In Japanese Patent Laid-Open No. 2012-111226, the support material includes a water-soluble material. Therefore, by dipping the three-dimensional object having the structure portion and the support portion in water, the support portion can be selectively removed. Thus, it is preferable from the viewpoint of ease of removal of the support material that the support material can be removed by bringing the same with a liquid containing water.

### SUMMARY

To the support material described in Japanese Patent Laid-Open No. 2012-111226, non-water-soluble materials, such as metal power, organic powder, and fibers, can be added for various purposes of improving the strength of the support portion, for example. The non-water-soluble materials do not dissolve in water, and therefore the support material to which the non-water-soluble material is added has had a problem in that the removability by a liquid containing water decreases as compared with one to which the non-water-soluble material is not added.

Then, in view of the above-described problem, a support material containing a water-soluble material and a non-water-soluble material and having removability higher than that in a former support material is provided.

Further features of the present disclosure will become apparent from the following description of exemplary embodiments with reference to the attached drawings.

### BRIEF DESCRIPTION OF THE DRAWINGS

FIG. 1A is a schematic view illustrating a first configuration example of a shaping device according to a first embodiment.

FIG. 1B is a schematic view illustrating a shaped substance according to the first embodiment.

FIG. 1C is a schematic view illustrating an object according to the first embodiment.

FIG. 2A is a schematic view illustrating a second configuration example of a shaping device according to a second embodiment.

FIG. 2B is a schematic view illustrating shaped substance according to the second embodiment.

FIG. 2C is a schematic view illustrating an object according to the second embodiment.

FIG. 3A is a schematic view illustrating a method of dipping as part of a method for removing a support portion according to an embodiment.

FIG. 3B is a schematic view illustrating a first method of removing liquid as part of the method for removing the support portion according to the embodiment of FIG. 3A.

FIG. 3C is a schematic view illustrating a second method of removing liquid as part of the method for removing the support portion according to the embodiment of FIG. 3A.

### DESCRIPTION OF THE EMBODIMENTS

Hereinafter, embodiments of the present disclosure are described in detail referring to the drawings as appropriate. However, the present invention is not limited to the embodiments described below. Embodiments obtained by altering and modifying, for example, the embodiments described later based on the knowledge of a person skilled in the art without departing the scope of the present disclosure are also included in the present invention.

### Shaping Materials

First, shaping materials to be used in the present disclosure are described. In this embodiment, a non-water-soluble structural material and a support material containing a water-soluble material are used as the shaping materials.

In this disclosure, the “shaping materials” refer to shaping materials to be used in producing a three-dimensional object. The shaping materials are classified into a structural material (model material) forming a target three-dimensional object and a support material supporting a laminate of the structural materials. A support portion formed with the support material is a portion supporting the structural material to be laminated on a region where the structural material is not present and is finally removed.

In this disclosure, “shaping material particles” refer to particulate shaping materials. The shaping material particles are classified into “structural material particles (model material particles)” which are particulate structural materials and “support material particles” which are particulate support materials. In this disclosure, powder containing the shaping material particles is referred to as “shaping material powder”, powder containing the structural material particles is referred to “structural material powder,” and powder containing the support material particles is referred to as “support material powder.”

The average particle diameter on a volume basis of the shaping material particles is preferably 1 μm or more and 100 μm or less and more preferably 20 μm or more and 80 μm or less. By setting the particle diameter of the shaping material particles to 1 μm or more, the laminated layer thickness of one laminating process in a laminating process described later can be made thick, and therefore a three-dimensional object having a desired height can be obtained with a small number of times of lamination. By setting the particle diameter of the shaping material particles to 100 μm or less, a three-dimensional object having high shape accuracy and dimensional accuracy is easily obtained. The average particle diameter on a volume basis of the shaping material particles can be measured using a commercially available laser diffraction scattering particle size distribution meter.

### Structural Material

As the structural material forming a three-dimensional object, a non-water-soluble material is used. In this embodiment, the structural material and the support material disposed according to cross-sectional data are heated to be fusion-bonded with each other to be laminated, whereby a three-dimensional object is produced as described later. Therefore, as the structural material according to this embodiment, thermoplastic materials, such as thermoplastic resin and metal materials and inorganic material having thermoplasticity can be suitably used. The “thermoplasticity” refers to a property that a material is difficult to deform at a normal temperature but, when heated at a temperature suitable for the material, the material demonstrates plasticity, so that the material can be freely deformed and then, when cooled again, the material is re-hardened.

Examples of the thermoplastic resin include ABS (acrylonitrile butadiene styrene), PP (polypropylene), PE (polyethylene), PS (polystyrene), PMMA (acryl), PET (polyethylene terephthalate), PPE (polyphenylene ether), PA (nylon/polyamide), PC (polycarbonate), POM (polyacetal), PBT (polybutylene terephthalate), PPS (polyphenylene sulfide), PEEK (polyetheretherketone), LCP (liquid crystal polymer), fluororesin, urethane resin, elastomer, and the like but are not limited thereto. The structural material may further contain functional substances, such as pigments and dispersants which disperse pigments, according to the function of a target three-dimensional object.

In the case of using a non-water-soluble material for the structural material, when a material removable by water is used as the support material forming the support portion, the support portion can be selectively removed by water from a three-dimensional object after lamination. When the support portion can be removed using water, the cost required for the removal of the support portion can be reduced because water is easily available. Furthermore, water has high safety and a low load on the environment, and therefore it is very suitable to use water for the removal of the support portion.

Herein, the “non-water-soluble” in this disclosure refers to a property that the solubility in water is less than 1. The “water-soluble” refers to a property that the solubility in water is 1 or more. The “solubility in water” refers to a value expressing the mass in which a material dissolves in 100 g of pure water having a water temperature of 20° C. at one atmospheric pressure with a gram unit.

### Support Material

The support material according to this embodiment contains at least one of low molecular weight saccharides, polyvinyl alcohols, and polyalkylene glycols, non-water-soluble cellulose fibers (B), and water-soluble cellulose derivative (C).

### Water-Soluble Base Material (A)

The support material according to this embodiment contains a water-soluble base material (A). Therefore, the support portion formed with the support material containing the water-soluble base material (A) also contains the water-soluble base material (A) or a water-soluble material derived from the water-soluble base material (A). Therefore, when the support portion is brought into contact with a liquid containing water (hereinafter referred to as “removing liquid”), a portion containing the water-soluble material contained in the support portion dissolves to be removed from a three-dimensional object. Then, a portion containing the non-water-soluble cellulose fibers (B) is also washed away, which results in the fact that the support portion is removed from a three-dimensional object.

When the solubility in water of the water-soluble base material (A) is larger, the dissolution in water of the portion containing the water-soluble material contained in the support portion can be more easily performed. Therefore, the removal of the support portion with the removing liquid can be facilitated.

Herein, in this disclosure, the “polyvinyl alcohols” contain polyvinyl alcohol and derivatives thereof and the “polyalkylene glycols” contain polyalkylene glycol and derivatives thereof.

The low molecular weight saccharides are suitably saccharides having a molecular weight of 100 or more and 1000 or less and more suitably saccharide or sugar alcohol having a molecular weight of 100 or more and 1000 or less. As the saccharide having a molecular weight of 100 or more and 1000 or less, monosaccharide, disaccharide, trisaccharide, tetrasaccharide, pentasaccharide, or oligosaccharide having a molecular weight of 1000 or less is suitably used. As the sugar alcohol having a molecular weight of 100 or more and 1000 or less, sugar alcohol derived from monosaccharide, sugar alcohol derived from disaccharide, sugar alcohol derived from trisaccharide, sugar alcohol derived from tetrasaccharide, or sugar alcohol derived from oligosaccharide having a molecular weight of 1000 or less is suitably used. The “sugar alcohol derived from X-saccharide” as used herein refers to sugar alcohol obtained by reducing X-saccharide.

The low molecular weight saccharide is particularly suitably at least one selected from the group consisting of monosaccharide, disaccharide, trisaccharide, tetrasaccharide, pentasaccharide, sugar alcohol derived from monosaccharide, sugar alcohol derived from disaccharide, sugar alcohol derived from trisaccharide, sugar alcohol derived from tetrasaccharide, and sugar alcohol derived from pentasaccharide.

The low molecular weight saccharides may contain only one type of saccharide or contain a plurality of types of saccharides. Herein, the “type” of the low molecular weight saccharides is determined by the chemical structure. A low molecular weight saccharide having a different chemical structure is described as a low molecular weight saccharide of a different type.

Specific examples of the low molecular weight saccharides include, for example, monosaccharides, such as glucose, xylose, and fluctus; disaccharides, such as sucrose, lactose, maltose, trehalose, and isomaltulose (Palatinose®); trisaccharides, such as melezitose, maltotriose, nigerotriose, raffinose, and kestose; tetrasaccharides, such as maltotetraose and stachyose; and pentasaccharides.

Specific examples of the low molecular weight saccharides include, for example, oligosaccharides having a molecular weight of 100 or more and 1000 or less among isomaltooligosaccharide, fructooligosaccharide, xylooligosaccharide, soybean oligosaccharide, galactooligosaccharide, nigerooligosaccharide, and lactose oligosaccharide; and oligosaccharide alcohols having a molecular weight of 100 or more and 1000 or less.

Specific examples of the low molecular weight saccharides include, for example, sugar alcohols derived from monosaccharides, such as xylitol, sorbitol, mannitol, and erythritol; sugar alcohols derived from disaccharides, such as maltitol and lactitol; sugar alcohols derived from trisaccharides; sugar alcohols derived from tetrasaccharides; and sugar alcohols derived from pentasaccharides; but are not limited thereto.

Specific examples of the polyvinyl alcohols include, for example, polyvinyl alcohol (PVA), ethylene/vinylalcohol copolymer (EVOH), and butenediol vinylalcohol copolymer (BVOH) but are not limited thereto. Specific examples of the polyalkylene glycols include, for example, polyethylene glycol (PEG), polyethylene oxide (PEO), polypropylene glycol (PPG), and polypropylene oxide (PPO) but are not limited thereto.

In order to facilitate the removal of the support portion by water, the mass fraction of the water-soluble base material (A) occupying the entire support material is preferably 50% by mass or more and more preferably 70% by mass or more. The upper limit is not particularly limited. The mass fraction of the water-soluble base material (A) occupying the entire support material may be 95% by mass or less or may be 90% by mass or less. Therefore, the total content of the low molecular weight saccharides, the polyvinyl alcohols, and the polyalkylene glycols is suitably 50% by mass or more and 95% by mass or less when the entire support material is set to 100% by mass.

The support material may contain one type of water-soluble material or a plurality of types of water-soluble materials as the water-soluble base material (A). When the support material contains a plurality of types of water-soluble materials as the water-soluble base material (A), the mass fraction of the water-soluble base material (A) occupying the entire support material may be calculated from the total amount of the water-soluble materials. Herein, the “type” of the water-soluble material is determined by the chemical structure. A water-soluble material having a different chemical structure is described as a water-soluble material of a different type.

By compounding a plurality of types of materials as the water-soluble base material (A), various properties, such as viscoelasticity properties and the softening temperature, of the support material can be adjusted to desired values. In this embodiment, a first water-soluble organic material and a second water-soluble organic material are suitably compounded as the water-soluble base material (A).

In this embodiment, by the use of an amorphous material as the first water-soluble organic material, the hysteresis between the viscoelasticity properties in heating and the viscoelasticity properties in cooling can be reduced. By the use of a crystalline material as the second water-soluble organic material, the softening temperature of the support material can be adjusted. The second water-soluble organic material is suitably a material having a melting point of 60° C. or more and 180° C. or less. Thus, the degree of freedom in a temperature range in an additive manufacturing process can be improved. Specifically, as the first water-soluble organic material, maltotetraose is usable and, as the second water-soluble organic material, sugar alcohols, such as mannitol, lactitol, and erythritol, are usable.

The water-soluble base material (A) is not particularly limited insofar as the material has water-solubility. The solubility in water of the water-soluble base material (A) is preferably 5 or more, more preferably 10 or more, and still more preferably 50 or more.

Herein, the “softening temperature” refers to a temperature at which the storage elastic modulus starts to considerably decrease with an increase in the temperature when a substance is heated. In this disclosure, the softening temperature is a temperature at which the loss tangent (tan δ) which is a ratio of the storage elastic modulus and the loss elastic modulus (G″/G′) reaches the maximum when the temperature dependency of the dynamic viscoelasticity is measured using a rotary rheometer, and the tan δ is plotted to the temperature.

The “storage elastic modulus (G′)” refers to the degree of elasticity of a substance. The “elasticity” generally indicates the property of a solid and refers to a property that a certain substance is deformed by applying a fixed external force, and then, after the external force is removed, the shape of the deformed substance is returned to the shape before the external force is applied. On the other hand, the “loss elastic modulus (G″)” refers to the degree of viscosity of a substance. The “viscosity” generally indicates the property of liquid and refers to a property that a certain substance is deformed by applying a fixed external force, and then, even when the external force is removed, the shape of the deformed substance does not return to the shape before the external force is applied.

### Non-Water-Soluble Cellulose Fibers (B)

The support material according to this embodiment contains non-water-soluble cellulose fibers (B) (hereinafter referred to as “cellulose fibers (B)”). By compounding the cellulose fibers (B) in the support material, various properties of the support material can be adjusted. For example, the softening temperature, the viscoelasticity properties, the hygroscopicity, the chargeability, and the like of the support material can be adjusted or the dynamic strength of the support portion can be adjusted.

Due to the fact that the support material according to this embodiment contains the cellulose fibers (B) as fibrous materials, a three-dimensional network structure due to the cellulose fibers (B) is formed in the support material. Due to the formation of such a three-dimensional network structure in the support material, even when the water-soluble base material (A) tends to have viscosity to flow, the flow can be prevented. Therefore, even when the viscosity of the water-soluble base material (A) increases by heating the support material, the flow of the water-soluble base material (A) can be prevented and the increase in the viscosity of the entire support material can be prevented. As a result, the viscoelasticity properties, such as the storage elastic modulus and the loss elastic modulus, of the support material can be effectively adjusted. It can be presumed that the properties other than the viscoelasticity properties can be effectively adjusted by the formation of the three-dimensional network structure.

It is suitable for the cellulose fibers (B) to have a storage elastic modulus larger than the storage elastic modulus of the water-soluble base material (A) in a temperature range in a heating and fusion-bonding process described later. Herein, when the support material contains a plurality of types of water soluble materials as the water-soluble base material (A), the description “larger than the storage elastic modulus of the water-soluble base material (A)” refers to the fact that the storage elastic modulus is larger than the storage elastic modulus of any water-soluble material contained as the water-soluble base material (A) in the support material. By compounding the cellulose fibers (B) having a storage elastic modulus larger than that of the water-soluble base material (A) in the support material, the storage elastic modulus of the entire support material can be increased. The cellulose fiber (B) is suitably a material having a storage elastic modulus larger than the loss elastic modulus in a temperature range in the heating and fusion-bonding process.

It is suitable that the cellulose fibers (B) are almost uniformly distributed in the support material. When the distribution of the cellulose fibers (B) in the support material has a deviation, various properties, such as the viscoelasticity properties, become uneven inside the support material. As a result, there is a possibility that irregularities are formed in the upper surface or the lower surface of a layer formed using the support material. Then, in order to improve the smoothness of the upper surface and the lower surface of the layer to be formed, the distribution of the cellulose fibers (B) inside the support material is suitably almost uniform. When the support material is a particulate support material, the cellulose fibers (B) are suitably almost uniformly distributed among a plurality of particles.

When the support material is a particulate support material (support material particles), it is suitable for the cellulose fibers (B) to have a size sufficiently smaller than the particle diameter of the support material particles. Also when the support material is not a particulate support material, it is suitable for the cellulose fibers (B) to have a size sufficiently smaller than the lamination pitch in laminating the support material. Herein, the particle diameter and the lamination pitch described above are suitably set to about 5 μm to 100 μm. Therefore, the cellulose fibers (B) are suitably fibrous materials having an average fiber diameter of a submicron size or a nanosize. Hereinafter, the above-described fibrous materials are sometimes referred to as “nanofibers”. Thus, the dispersibility of the cellulose fibers (B) in the support material can be increased. Moreover, the dispersibility in water of the cellulose fibers (B) in the support material can be increased.

The average fiber diameter of the nanofibers to be used as the cellulose fibers (B) in this embodiment is preferably 1 nm or more and 500 nm or less, more preferably 1 nm or more and 100 nm or less, and particularly preferably 1 nm or more and 50 nm or less. The length of the nanofibers is preferably 4 times or more, more preferably 10 times or more, and particularly preferably 50 times or more the average fiber diameter. By setting the length of the nanofibers to be sufficiently larger than the average fiber diameter, the above-described network structure in the support material can be uniformly formed.

The diameter of the support material particles is suitably set to 100 μm or less as described above, and therefore the length of the nanofibers is suitably set to a length according to the diameter. Specifically, the length of the nanofibers is preferably 100 μm or less, more preferably 50 μm or less, and particularly preferably 30 μm or less. The lower limit value of the length of the nanofibers is not particularly limited and is preferably 1 μm or more and more preferably 5 μm or more.

It is suitable that the cellulose fibers (B) do not react with or are not compatible with the water-soluble base material (A) or the cellulose fibers (B) themselves are not denatured in a temperature range in the heating and fusion-bonding process.

From the description above, cellulose nanofibers are particularly suitably used as the cellulose fibers (B). The cellulose nanofiber is also sometimes referred to as cellulose nanofibril, cellulose microfibril, nanofibrillated cellulose, microfibrillated cellulose, or the like.

The mass fraction of the cellulose fibers (B) to the entire support material can be arbitrarily adjusted according to the type of the water-soluble base material (A) or the mass fraction of the water-soluble base material (A) to the entire support material. In that case, the mass fraction of the cellulose fibers (B) is suitably adjusted in such a manner that the storage elastic modulus of the support material always exceeds the loss elastic modulus of the support material.

As described above, the support portion formed by laminating the support material is removed by bringing the support portion into contact with a removing liquid in a support portion removing process described later. The removal of the support portion proceeds due to the dissolution of the water-soluble base material (A) in the liquid. Therefore, when the ratio of the cellulose fibers (B) occupying the entire support material is excessively large, the support portion is difficult to remove by the removing liquid. Therefore, the mass fraction of the cellulose fibers (B) occupying the entire support material is preferably less than 50% by mass, more preferably 40% by mass or less, and still more preferably 30% by mass or less.

When the amount of the cellulose fibers (B) is excessively small, the adjustment effect of various properties by the cellulose fibers (B) decreases. Therefore, the mass fraction of the cellulose fibers (B) to the entire support material is not particularly limited and is preferably 10% by mass or more and more preferably 15% by mass or more.

Therefore, the content of the cellulose fibers (B) is preferably 10% by mass or more and less than 50% by mass, more preferably 15% by mass or more and less than 50% by mass, and particularly preferably 15% by mass or more and 30% by mass or less when the total mass of the support material is set to 100% by mass.

### Water-Soluble Cellulose Derivative (C)

As described above, the support material according to this embodiment contains the water-soluble base material (A) and the cellulose fibers (B) and the support portion formed using the support material is removed by being brought into contact with a removing liquid. In this process, the water-soluble base material (A) or a material derived from the water-soluble base material (A) contained in the support portion is dissolved in the removing liquid to be removed and the cellulose fibers (B) are dispersed in the removing liquid to be removed.

In this process, when the content ratio of the cellulose fibers (B) in the entire support material is large, the efficiency in removing the support portion (removal efficiency) decreases. The cellulose fibers (B) have three hydroxyl groups in a glucopyranose monomer (glucose unit) forming the cellulose skeleton. When the cellulose fibers (B) are attempted to be dispersed in a removing liquid, the cellulose fibers (B) cause hydrogen-bonding via the hydroxyl groups, so that two or more of the cellulose fibers (B) are aggregated in some cases. This is conspicuous when the average fiber diameter of the cellulose fibers (B) is small, particularly in the case of cellulose nanofibers. Thus, when the cellulose fibers (B) are aggregated, the removal efficiency of the cellulose fibers (B) decreases, which results in a reduction in the removal efficiency of the support portion.

Furthermore, when cellulose nanofibers are used as the cellulose fibers (B), the cellulose fibers (B) are gelled when the support portion is brought into contact with a removing liquid to form a barrier layer preventing the contact between a portion containing the water-soluble base material (A) and the removing liquid. As a result, the removal efficiency of the support portion remarkably decreases.

The support material according to this embodiment contains a water-soluble cellulose derivative (C) (hereinafter referred to as a “cellulose derivative (C)”) in addition to the water-soluble base material (A) and the cellulose fibers (B). The cellulose derivative (C) has a function of preventing the aggregation of the cellulose fibers (B) in a removing liquid.

By compounding the cellulose derivative (C) in the support material, the cellulose derivative (C) is also contained in the support portion formed using the support material. When the support portion and a removing liquid are brought into contact with each other, the aggregation or the gelling of the cellulose fibers (B) described above can be prevented because the aggregation of the cellulose fibers (B) is prevented by the cellulose derivative (C), and therefore the removal efficiency of the support portion can be increased.

A specific mechanism is not clarified but the present inventors presume the mechanism that the removal efficiency of the support portion increases by the cellulose derivative (C) as follows.

The cellulose derivative (C) has the cellulose skeleton as with the cellulose fibers (B) and at least one of the hydroxyl groups in the glucopyranose monomer forming the cellulose skeleton is ester or ether. For example, in carboxymethyl cellulose, the at least one of the hydroxyl groups is ether-bonded to a carboxymethyl group and, in hydroxypropyl cellulose, the at least one of the hydroxyl groups is ether-bonded to a hydroxypropyl group.

The cellulose derivative (C) has the cellulose skeleton and causes hydrogen-bonding with the cellulose fibers (B) to be bonded. However, in the cellulose derivative (C), at least one of the hydroxyl groups in the glucopyranose monomer forming the cellulose skeleton is ester or ether as described above, and therefore the bonding power between the cellulose derivative (C) and the cellulose fiber (B) is lower than the bonding power between the cellulose fibers (B).

When the cellulose derivative (C) contacts a removing liquid, the cellulose derivative (C) dissolves in the removing liquid. Moreover, the cellulose fibers (B) are dispersed in the removing liquid. When the cellulose derivative (C) is present near the cellulose fibers (B) in the removing liquid, hydrogen-bonding arises not between the cellulose fibers (B) but between the cellulose fiber (B) and the cellulose derivative (C). Therefore, strong aggregation of the cellulose fibers (B) can be prevented. The bonding power between the cellulose fibers (B) and the cellulose derivative (C) is lower than the bonding power between the cellulose fibers (B) as described above. Therefore, even when the cellulose fibers (B) and the cellulose derivative (C) are bonded once, the cellulose fibers (B) and the cellulose derivative (C) are easily separated from each other. As a result, the removal efficiency of the support portion can be increased.

The glucose unit forming the cellulose fibers (B) has a chair conformation. In this structure, only C and H are disposed in the vertical direction to the pyranose ring in the glucose unit and hydroxyl groups are disposed in the horizontal direction to the pyranose ring. Due to the structure, the cellulose fibers (B) show hydrophobicity in the vertical direction to the pyranose ring and shows hydrophilicity in the horizontal direction to the pyranose ring, and, inside the cellulose fibers (B), both a hydrophobic site and a hydrophilic site are localized. The cellulose derivative (C) is adsorbed to the hydrophobic site of the cellulose fibers (B) to demonstrate protective colloid properties. It is considered that, due to the protective colloid properties, the removal efficiency of the support portion increases.

As the cellulose derivative (C), an anionic cellulose derivative or a nonionic cellulose derivative is suitably used.

As the anionic cellulose derivative, a carboxymethyl cellulose salt is suitably used. The carboxymethyl cellulose salt is a water-soluble polymer and dissolves in contact with a removing liquid to produce carboxymethyl cellulose anion and efficiently coordinates on cellulose nanofibers. As a result, the aggregation or the gelling of the cellulose nanofibers can be prevented.

As the carboxymethyl cellulose salt, sodium salt (sodium carboxymethyl cellulose) is suitably used and potassium, ammonium, lithium, and other salts may be acceptable.

Examples of the nonionic cellulose derivative include hydroxypropyl cellulose, hydroxyethyl cellulose, hydroxypropylethyl cellulose, and the like but are not limited thereto.

The mass fraction (content) of the cellulose derivative (C) to the entire support material is not particularly limited and is preferably 0.05% by mass or more and 20% by mass or less when the entire support material is set to 100% by mass. The mass fraction is more preferably 0.05% by mass or more and 10% by mass or less and particularly preferably 0.1% by mass or more and 10% by mass or less. When the content of the cellulose derivative (C) is smaller than 0.05% by mass, the effect of preventing the aggregation or the gelling of the cellulose fibers (B) is not sufficiently obtained. The cellulose derivative (C) is suitably a material which dissolves in a removing liquid. However, the water solubility thereof is not higher than the water solubility of the water-soluble base material (A) in many cases. Therefore, when the content of the cellulose derivative (C) is larger than 10% by mass, the efficiency in removing the support portion decreases. The content of the cellulose derivative (C) can be adjusted as appropriate according to the likelihood of the aggregation or the gelling of the cellulose fibers (B).

The amount of the cellulose derivative (C) to the cellulose fibers (B) is not particularly limited and is preferably 0.3% by mass or more and 70% by mass or less when the mass of the cellulose fibers (B) contained in the support material is set to 100% by mass. The amount is more preferably 0.5% by mass or more and 40% by mass or less.

### Shell

When the support material according to this embodiment is a particulate support material (support material particles), it is suitable for the support material particles to further have a shell covering at least one part of the particle surface. Herein, the solubility in water of a material contained most in the shell is smaller than the solubility in water of the water-soluble base material (A). The shell may contain a plurality of types of materials. As the shell material (D), a material having solubility in water of smaller than 10 is suitable, a material having solubility in water of smaller than 5 is more suitable, and a material having solubility in water of less than 1 is still more suitable. More specifically, the shell material (D) is particularly suitably a non-water-soluble material.

The support material containing the water-soluble base material (A) tends to absorb moisture to increase the viscosity of the surface in an environment in which the moisture amount is large, such as a high humidity environment. This tendency is conspicuous in a particulate support material having a large surface area. Due to the fact that the support material particles have the above-described shell, the moisture absorption of the support material particles can be prevented, so that the increase in the viscosity of the surface can be prevented. Therefore, the storage property of the support material particles increases and the handling thereof is facilitated.

Due to the mechanism presumed as follows, even when the support material particles have a shell covering the entire particle surface, the support portion formed with the support material particles can be removed by bringing the support portion into contact with a removing liquid.

More specifically, in the heating and fusion-bonding process of fusion-bonding the support material particles or the structural material particles to each other in the process of producing a three-dimensional object, the particles are fusion-bonded to each other due to the disappearance of the interface between the particles, so that a layer (sheet) or a shaped substance is formed. Herein, the volume ratio of the shell in the entire support material particles is sufficiently smaller than the volume ratio of the water-soluble base material (A) in the entire support material particles, and therefore the shell is broken. More specifically, the support portion is formed in a state where the cellulose fibers (B), the cellulose derivative (C), shell fragments, and the like are dispersed in the network (matrix) containing the water-soluble base material (A). Therefore, the support portion formed with the support material particles according to this embodiment can be easily removed from a shaped substance by bringing the network of the water-soluble base material (A) into contact with water.

Examples of the shell material (D) include organic substances typified by organic compounds and polymer compounds, inorganic substances typified by metals, ceramics, and the like, and composites thereof but are not limited to the materials above.

Examples of the organic substances mentioned above include resin substances, such as vinyl-based resin, polyester resin, epoxy resin, and urethane resin, ester compounds, such as glycerol fatty acid esters, sucrose fatty esters, and sorbitan fatty acid esters, and some cellulose derivatives, such as ethyl cellulose, but are not limited thereto.

Examples of the inorganic substances include inorganic oxides, such as silicon oxide, titanium oxide, and alumina, but are not limited thereto.

It is suitable that the water-soluble base material (A) and the shell material (D) are different from each other. Due to the fact that the water-soluble base material (A) and the shell material (D) are different from each other, the mixing of the water-soluble base material (A) and the shell material (D) is prevented in fusion-bonding the support material particles, so that the effects described herein are easily obtained.

### Shape of Support Material

The shape of the support material according to this embodiment is not particularly limited. For example, when the support material according to this embodiment is applied to additive manufacturing of a type including performing shaping using a powder-like shaping material (shaping material powder), the support material may be a particular support material (support material particles) or support material powder which is an aggregate of the support material particles. Examples of the additive manufacturing of such a type include a selective laser sintering (SLS) method, a binder jetting method, an electrophotographic method, and the like. When the support material according to this embodiment is applied to additive manufacturing of a fused deposition modeling (FDM) method, the support material may be a support material of a pellet shape, a rod shape, or a filament shape.

### Method for Producing Support Material Powder

A method for producing support material powder (aggregate of support material particles) according to this embodiment is not particularly limited. As an example of a method for obtaining support material powder according to this embodiment, the following methods are mentioned.

As a first method, a method (spray drying method) is mentioned which employs one in which the cellulose fibers (B) are dispersed in a solution containing the water-soluble base material (A) and the cellulose derivative (C) as a raw material liquid and which includes spraying the raw material liquid into a gas, and then rapidly cooling the same to obtain support material powder. According to this method, the average particle diameter or the circularity of the support material particles contained in the support material powder can be relatively made uniform, and therefore the method is suitable.

As a second method, a method (kneading and pulverizing method) is mentioned which includes melting and kneading the water-soluble base material (A), the cellulose fibers (B), and the cellulose derivative (C) to obtain a solid, and then pulverizing the obtained solid to obtain support material powder. According to this method, the support material powder can be produced at a low cost.

As the other methods, a mechanical pulverizing method including mechanically pulverizing and mixing each component, a melting dispersion cooling method including dispersing each component in a molten state in a medium and cooling the same to thereby obtain particles, and the like may be used.

### Method for Producing Three-Dimensional Object

Next, an example of a method for producing a three-dimensional object using the support material of this embodiment is described. The method for producing a three-dimensional object according to this embodiment is a method for producing a three-dimensional object substantiating a three-dimensional model (shaping target) by forming material layers from the shaping materials according to slice date of the three-dimensional model, and then laminating the material layers.

The “slice data” as used herein may be a plurality of slice image data generated by slicing model data of the three-dimensional model at predetermined intervals in the lamination direction. In the method, each slice image data is data including two-dimensional arrangement information of the shaping material of each layer. The slice image data is suitably usable for additive manufacturing of a type including forming material layers by the shaping materials, and then laminating the formed material layers. Or, the “slice data” may be tool path data including path information of disposing the shaping material. The tool path data is suitably usable for additive manufacturing of the fused deposition modeling (FDM) method.

It can also be said that a method for producing a three-dimensional object according to this embodiment has a material layer formation process of forming material layers containing shaping materials according to the slice data of the three-dimensional model, and a material layer lamination process of laminating the material layers. The material layer lamination process may be a process of forming a second material layer on a first material layer formed in the material layer formation process or may be a process of laminating, on the first material layer, a second material layer formed at a place other than a place on the first material layer.

The method for producing a three-dimensional object according to this embodiment has the following processes [1] and [2]:

(1) First process of forming a shaped substance containing a structure portion forming a three-dimensional object and a support portion supporting the structure portion (Shaped substance formation process); and
(2) Second process of removing the support portion from the shaped substance by bringing the shaped substance into contact with a liquid containing water to form the three-dimensional object (Removal process).

Hereinafter, each process is described in detail.

### 1. Shaped Substance Formation Process

This process is a process of forming a shaped substance containing a structure portion forming a three-dimensional object and a support portion supporting the structure portion by additive manufacturing. By the additive manufacturing, the structure portion is formed using at least one type of structural material according to slice data of a three-dimensional model, and then a support portion is formed using at least one type of support material. In this embodiment, the support material of the present disclosure is used as the support material forming the support portion.

The shaped substance formation process may have the following processes of (1a) and (1b).

1a. Material Layer Formation Process

This process is a process of disposing a structural material and, as necessary, a support material according to slice data of a three-dimensional model to form a material layer.

Herein, synthetic data is used in which the slice data of the support portion is added to slice data generated from a three-dimensional model of a shaping target. The slice data (synthetic data) may be generated by performing slice processing in a state where model data of a support portion is added to the three-dimensional model before generating the slice data from the three-dimensional model. Alternately, after slice data is generated from a three-dimensional model, slice data of a support portion may be added to the slice data of the three-dimensional model. The “slice data of three-dimensional model” in this disclosure also includes synthetic data in which the slice data of the support portion is added as necessary as described above.

A method for disposing the structural material and the support material is not particularly limited and various methods for use in the additive manufacturing are usable. In particular, it is suitable to use the fused deposition modeling (FDM) method or the electrophotographic method. According to these methods, each of a plurality of types of shaping materials can be easily disposed according to the slice data.

1b. Material Layer Lamination Process

This process is a process of repeatedly laminating the material layer formed in the material layer formation process to form a shaped substance. As the lamination of the material layer, a material layer formed as another layer may be laminated on the surface of a material layer formed previously or a new material layer may be directly formed and laminated on the surface of a material layer formed previously. When laminating the material layer formed as another layer on the surface of the material layer formed previously, the material layer may be formed once on a base material, and then transferred onto the surface of the material layer formed previously. The base material used in this process is referred to as a transfer body. When transferring the material layer onto the transfer body, known transfer methods, such as electrostatic transfer using electrostatic energy or heat transfer using thermal energy, are usable.

In the shaped substance formation process, the shaped substance is formed by repeating the processes [1a] and [1b] two or more times, e.g., the number of times corresponding to the slice data of the three-dimensional model.

### 2. Removal Process

This process is a process of removing the support portion of the shaped substance obtained by the process of [1] to obtain a three-dimensional object.

The removal of the support portion is performed by bringing the shaped substance into contact with a removing liquid.

As described above, the support material according to this embodiment contains the cellulose derivative (C), and therefore the cellulose derivative (C) is contained also in the support portion. Therefore, when the support portion is removed by a removing liquid, the cellulose derivative (C) prevents the aggregation of the cellulose fibers (B). As a result, the removal efficiency of the support portion by bringing the support portion into contact with the removing liquid can be increased.

The temperature of the removing liquid in the removal process is not particularly limited and the temperature of the removing liquid is suitably higher because the solubility of the water-soluble base material (A) increases and the removal efficiency of the support portion improves. The temperature of the removing liquid is suitably 60° C. or more and 80° C. or less, for example. However, it is suitable to determine the temperature according to the heat-resistant temperature of the structural material. When the structural material is ABS or PP, there is a possibility that, when the temperature is increased to 100° C., the structure portion is deformed by the heat. Therefore, the temperature of the removing liquid is suitably equal to or lower than the load deflection temperature of the structural material.

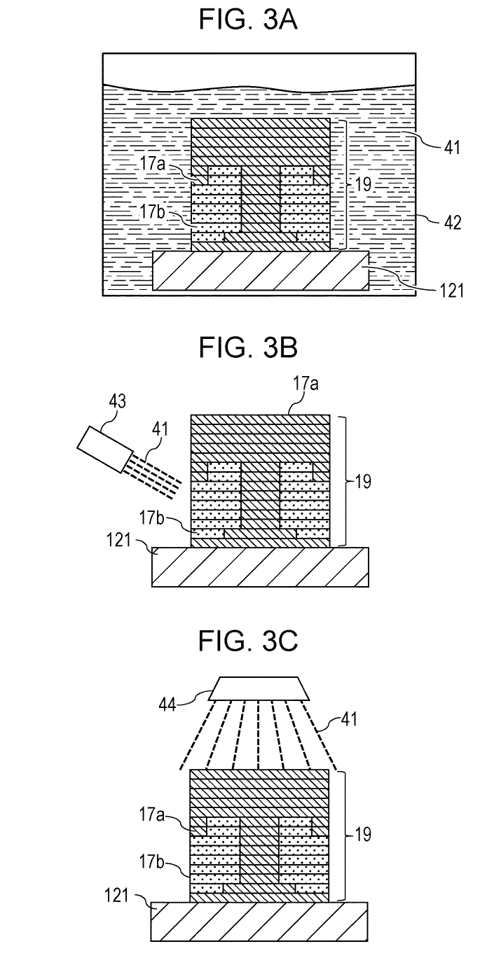

A method for bringing the shaped substance into contact with the removing liquid to remove the support portion from the shaped substance is not particularly limited insofar as a method allows uniform contact of the removing liquid with the support portion in the shaped substance. An example of a method for bringing the shaped substance into contact with the removing liquid is described with reference to FIGS. 3A to 3C. FIGS. 3A to 3C are views schematically illustrating a method for removing the support portion according to this embodiment.

For example, as illustrated in FIG. 3A, there is a method of dipping a shaped substance 19 in a liquid tank 42 storing a removing liquid 41 (dipping method). This method basically needs no manpower after the shaped substance 19 is dipped in the liquid tank 42, and therefore the support portion 17b can be very simply removed, and therefore the method is suitable.

In the method, it is suitable to irradiate the shaped substance 19 with ultrasonic waves while bringing the removing liquid 41 into contact with the shaped substance 19. Thus, the support portion 17b can be efficiently removed. A stirring device (not illustrated), such as a magnetic stirrer, may be disposed in the liquid tank 42 to generate a water current in the liquid tank 42. Thus, the support portion 17b can be more efficiently removed.

As illustrated in FIG. 3B, there is a method including pressurizing and jetting the removing liquid 41 by a pressure ejection device 43, and then jetting the removing liquid 41 in the shape of water jet to the shaped substance 19 (water jet method). Alternately, as illustrated in FIG. 3C, there is also a method including spraying the removing liquid 41 with a spray device 44 to spray the removing liquid 41 in the shape of spray to the shaped substance 19 (spraying method).

In particular, the water jet method enables not only dissolution of the water-soluble base material (A) forming the support portion 17b or a material originating from the water-soluble base material (A) for removal but blowing away of each component, such as the cellulose fibers (B), by the force of the water of the removing liquid 41. Thus, the support portion 17b can be more efficiently removed. When the shape of the three-dimensional object 20 has the strength which allows the three-dimensional object 20 to stand the water pressure of the removing liquid 41 in the shape of water jet, the water jet method is suitably used.

### Shaping Device

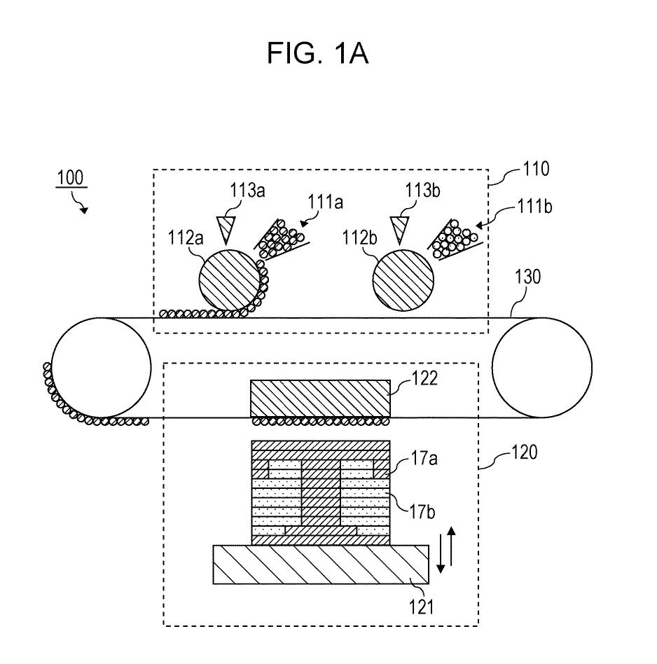

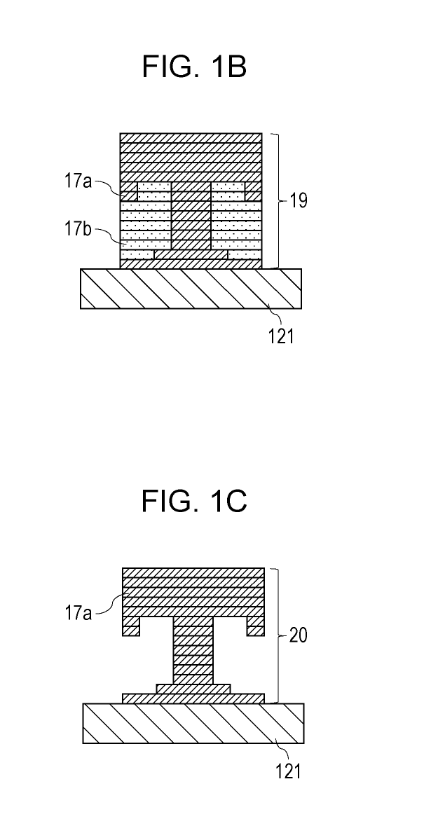

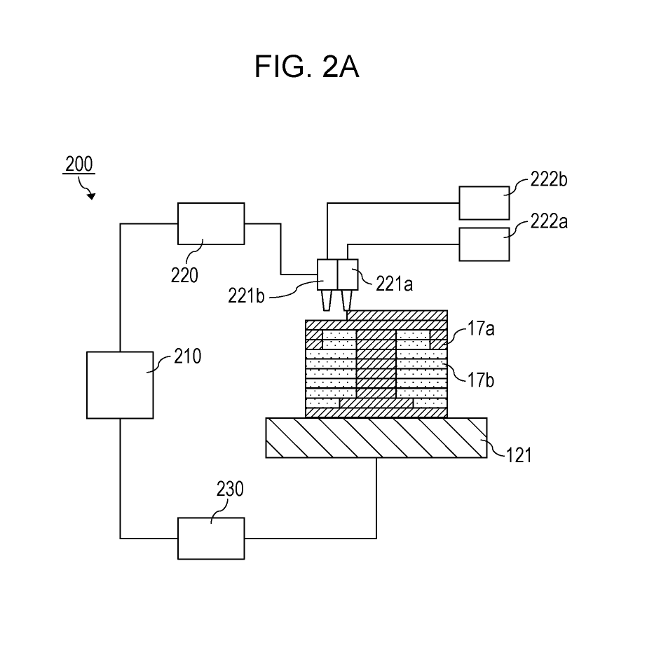

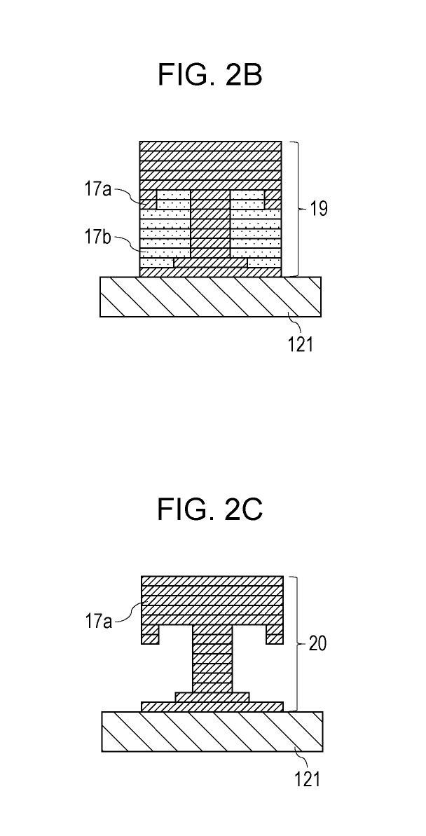

A Shaping device forming a shaped substance containing a structure portion forming a three-dimensional object and a support portion supporting the structure portion by additive manufacturing is described with reference to FIGS. 1A to 1C and FIGS. 2A to 2C. The Shaping device according to this embodiment employs the support material of the present disclosure as the support material forming the support portion.

FIGS. 1A to 1C are views schematically illustrating a first configuration example of the shaping device according to this embodiment. As illustrated in FIG. 1A, a shaping device 100 of the first configuration example has a particle layer formation portion 110, a laminating portion 120, and a conveyance body 130 conveying a particle layer formed by the particle layer formation portion 110 to the laminating portion 120. The configuration and the operation of the shaping device 100 according to this embodiment are described.

The particle layer formation portion 110 has material supply portions 111, image carrying bodies 112, and exposure devices 113. The particle layer formation portion 110 individually forms a particle image by structural material powder on an image carrying body 112a and a particle image by support material powder on an image carrying body 112b. Then, these particle images are transferred onto the conveyance body 130 to form a particle layer (material layer) containing the structural material powder and the support material powder.

Hereinafter, the formation process of the material layer is described in detail. In a description common about the formation of each particle image, subscripts a to d of the reference numerals of the constituent members are omitted, and the constituent members are indicated as the material supply portions 111, the image carrying bodies 112, and the like.

First, the surface of the image carrying bodies 112 is uniformly charged with a charging device (not illustrated). A charging method is not particularly limited.

The charged image carrying bodies 112 are exposed using the exposure devices 113 according to the slice data (cross-sectional data) of a shaped substance to be produced to form electrostatic latent images on the surface of the image carrying bodies 112. Specifically, an electrostatic latent image of a structure portion region in the slice data of the shaped substance to be produced is formed on the image carrying body 112a and an electrostatic latent image of a support portion region is formed on the image carrying body 112b.

Subsequently, shaping material powder (structural material powder or support material powder) is supplied to the image carrying bodies 112 from the material supply portions 111. Thus, the shaping material powder is disposed in either a region in which the electrostatic latent image was formed or a region in which the electrostatic latent image was not formed on the surface of the image carrying bodies 112. Thus, the electrostatic latent images can be visualized, so that a particle image by the structural material powder can be formed on the surface of the image carrying body 112a and the particle image by the support material powder can be formed on the surface of the image carrying body 112b.

Thereafter, the particle images disposed on the image carrying bodies 112a and 112b are transferred onto the conveyance body 130 at predetermined timing. Thus, a particle layer containing the particle image by the structural material powder and the particle image by the support material powder can be formed. More specifically, to a transfer body to which a first layer formed by the arrangement of either one of the structural material powder and the support material powder was transferred, a second layer formed by the arrangement of the other particles is transferred to form the particle layer. The order of transferring the particle images to the conveyance body 130 is not particularly limited and the particle image containing the support material powder may be transferred after the particle image containing the structural material powder was transferred or the images may be transferred in the reverse order.

Herein, a description is given with reference to the case where the particle layer formation portion 110 has two sets of the material supply portion 111, the image carrying body 112, and the exposure device 113 as an example but the present invention is not limited thereto. More specifically, when performing shaping using a plurality of types of structural material powder or a plurality of types of support material powder, the particle layer formation portion 110 may have the set corresponding to the number of the types of the shaping material powder (structural material powder and support material powder).

The particle layer formed on the conveyance body 130 is moved to a lamination position by the rotation of the conveyance body 130. When the particle layer is moved to the lamination position, the particle layer is heated by a temperature control unit 122, so that the particles forming the particle layer are fusion-bonded to each other. Then, the particle layer is transferred to and laminated on a shaped substance during of the generation formed on the upper surface of the stage 121 or on the stage 121.

In this process, a region containing the structural material powder of the particle layer is laminated as a portion (structure portion 17a) forming a three-dimensional object and a region containing the support material powder is laminated as a support portion 17b. More specifically, the lamination process in the method for producing a three-dimensional object according to this embodiment includes a heating and fusion-bonding process of heating the particle layer to fusion-bond the particles.

The timing of heating the particle layer to fusion-bond the particles forming the particle layer is not particularly limited and may be performed at any timing of before the lamination, simultaneously with the lamination, or after the lamination or the heating may be performed at two or more of the types of timing thereof.

In the heating and fusion-bonding process, both the structural material particles and the support material particles in the particle layer are heated by a temperature control unit 122, so that the temperatures of the particles are controlled to the almost same temperature. In this process, it is suitable for the temperature control unit 122 to heat both the structural material particles and the support material particles at a temperature where both the structural material particles and the support material particles are softened. Therefore, when the softening temperatures of the structural material particles and the support material particles are different from each other, it is suitable for the temperature control unit 122 to perform the heating at a higher softening temperature thereof.

The shaping device 100 according to this embodiment forms the shaped substance 19 as illustrated in FIG. 1B by repeating the material layer formation process and the material layer lamination process by the number of times corresponding to the slice data. Thereafter, the support portion 17b is removed by bringing the shaped substance 19 in a removing liquid, so that a three-dimensional object 20 as illustrated in FIG. 1C is obtained.

FIGS. 2A to 2C are views illustrating a second configuration example of the shaping device according to this embodiment. A shaping device 200 of the second configuration example is a device performing shaping by the fused deposition modeling (FDM) method. As illustrated in FIG. 2A, the shaping device 200 of the second configuration example has a shaping controller 210, a stage 121, and a stage actuator 230 driving the stage 121. The shaping device 200 further has a nozzle 221a ejecting a structural material, a nozzle 221b ejecting a support material, and a nozzle actuator 220 driving the nozzle 221a and the nozzle 221b. The shaping device 200 further has a material supply portion 222a supplying a structural material to the nozzle 221a and a material supply portion 222b supplying a support material to the nozzle 221b.

The shaping controller 210 generates a control signal for controlling the nozzle actuator 220 and/or the stage actuator 230 based on slice data (tool path data) of a shaped substance to be produced. The nozzle actuator 220 receives the control signal to control the operation and the material ejection amount of the nozzle 221a and the nozzle 221b. The stage actuator 230 receives the control signal to control the operation of the stage 121. Thus, a shaped substance 19 as illustrated in FIG. 2B is formed. Thereafter, the support portion 17b is removed by bringing the shaped substance 19 in contact with a removing liquid, so that a three-dimensional object 20 as illustrated in FIG. 2C is obtained.

### EXAMPLES

Hereinafter, Examples are described but the present invention is not limited by Examples.

### Preparation of Support Material Powder

Each support material powder was prepared by the following methods.

### Preparation Example 1

As the water-soluble base material (A), 2.95 kg of maltotetraose (NISSHOKU FUJI OLIGO#450, manufactured by NIHON SHOKUHIN KAKO CO., LTD) and 1.26 kg of lactitol anhydride LC-0 (manufactured by B Food Science Co., Ltd.) were used. As the cellulose fibers (B), 0.742 kg in terms of solid content of cellulose nanofibers (manufactured by DAICEL FINECHEM LTD.) was used. For the cellulose nanofibers, 3.71 kg of dispersion liquid (Celish FD-200L, manufactured by DAICEL FINECHEM LTD.) of cellulose nanofibers:water=20:80 (weight ratio) was used. As the cellulose derivative (C), 0.05 kg of sodium carboxymethylcellulose (CMC Daicel 1220, manufactured by DAICEL FINECHEM LTD.) was used. More specifically, the components were mixed in such a manner that the weight ratio of the cellulose fibers (B) and the weight ratio of the cellulose derivative (C) to the entire support material particles were 14.9% and 1.00%, respectively.

A dispersion liquid in which the water-soluble base material (A), the cellulose fibers (B), and the cellulose derivative (C) were dissolved or dispersed in 17.0 kg of water was prepared, and then powder was produced by a spray drying method using a spray drying device. By classifying the obtained powder, support material powder 1 with an average particle diameter of 25 m was obtained.

Herein, the measurement of the particle diameter was performed using a laser diffraction scattering type particle size distribution meter LA-950 (manufactured by HORIBA).

First, a batch cell containing a measurement solvent was set in the laser diffraction scattering type particle size distribution meter LA-950 (manufactured by HORIBA), and then the adjustment of the optical axis and the adjustment of the background were performed. As the solvent used at this time, one in which each particle contained in the powder does not dissolve needs to select. Herein, isopropyl alcohol (Special grade, manufactured by Kishida Chemical Co., Ltd.) was used. The powder to be measured was added to the batch cell until the transmittance of a tungsten lamp reached 95% to 90%, and then the particle size distribution was measured. From the obtained measurement result, the average particle diameter on a volume basis was calculated. Hereinafter, the measurement of the average particle diameter was similarly performed.

### Preparation Example 2

As the water-soluble base material (A), 2.97 kg of maltotetraose (NISSHOKU FUJI OLIGO#450, manufactured by NIHON SHOKUHIN KAKO CO., LTD) and 1.27 kg of lactitol anhydride LC-0 (manufactured by B Food Science Co., Ltd.) were used. As the cellulose fibers (B), 0.75 kg in terms of solid content of cellulose nanofibers (manufactured by DAICEL FINECHEM LTD.) was used. For the cellulose nanofibers, 3.75 kg of dispersion liquid (Celish FD-200L, manufactured by DAICEL FINECHEM LTD.) of cellulose nanofibers:water=20:80 (weight ratio) was used. As the cellulose derivative (C), 0.0050 kg of sodium carboxymethylcellulose (CMC Daicel 1220, manufactured by DAICEL FINECHEM LTD.) was used. More specifically, the components were mixed in such a manner that the weight ratio of the cellulose fibers (B) and the weight ratio of the cellulose derivative (C) to the entire support material particles were 15.0% and 0.100%, respectively.

A dispersion liquid in which the water-soluble base material (A), the cellulose fibers (B), and the cellulose derivative (C) were dissolved or dispersed in 17.0 kg of water was prepared, and then powder was produced by a spray drying method using a spray drying device. By classifying the obtained powder, support material powder 2 with an average particle diameter of 25 μm was obtained.

### Preparation Example 3

As the water-soluble base material (A), 2.97 kg of maltotetraose (NISSHOKU FUJI OLIGO#450, manufactured by NIHON SHOKUHIN KAKO CO., LTD) and 1.27 kg of lactitol anhydride LC-0 (manufactured by B Food Science Co., Ltd.) were used. As the cellulose fibers (B), 0.75 kg in terms of solid content of cellulose nanofibers (manufactured by DAICEL FINECHEM LTD.) was used. For the cellulose nanofibers, 3.75 kg of dispersion liquid (Celish FD-200L, manufactured by DAICEL FINECHEM LTD.) of cellulose nanofibers:water=20:80 (weight ratio) was used. As the cellulose derivative (C), 0.0025 kg of sodium carboxymethylcellulose (CMC Daicel 1220, manufactured by DAICEL FINECHEM LTD.) was used. More specifically, the components were mixed in such a manner that the weight ratio of the cellulose fibers (B) and the weight ratio of the cellulose derivative (C) to the entire support material particles were 15.0% and 0.050%, respectively.

A dispersion liquid in which the water-soluble base material (A), the cellulose fibers (B), and the cellulose derivative (C) were dissolved or dispersed in 17.0 kg of water was prepared, and then powder was produced by a spray drying method using a spray drying device. By classifying the obtained powder, support material powder 3 with an average particle diameter of 25 μm was obtained.

### Preparation Example 4

As the water-soluble base material (A), 2.97 kg of maltotetraose (NISSHOKU FUJI OLIGO#450, manufactured by NIHON SHOKUHIN KAKO CO., LTD) and 1.27 kg of lactitol anhydride LC-0 (manufactured by B Food Science Co., Ltd.) were used. As the cellulose fibers (B), 0.75 kg in terms of solid content of cellulose nanofibers (manufactured by DAICEL FINECHEM LTD.) was used. For the cellulose nanofibers, 3.75 kg of dispersion liquid (Celish FD-200L, manufactured by DAICEL FINECHEM LTD.) of cellulose nanofibers:water=20:80 (weight ratio) was used. As the cellulose derivative (C), 0.0005 kg of sodium carboxymethylcellulose (CMC Daicel 1220, manufactured by DAICEL FINECHEM LTD.) was used. More specifically, the components were mixed in such a manner that the weight ratio of the cellulose fibers (B) and the weight ratio of the cellulose derivative (C) to the entire support material particles were 15.0% and 0.01%, respectively.

A dispersion liquid in which the water-soluble base material (A), the cellulose fibers (B), and the cellulose derivative (C) were dissolved or dispersed in 17.0 kg of water was prepared, and then powder was produced by a spray drying method using a spray drying device. By classifying the obtained powder, support material powder 4 with an average particle diameter of 25 μm was obtained.

### Preparation Example 5

As the water-soluble base material (A), 2.98 kg of maltotetraose (NISSHOKU FUJI OLIGO#450, manufactured by NIHON SHOKUHIN KAKO CO., LTD) and 1.28 kg of lactitol anhydride LC-0 (manufactured by B Food Science Co., Ltd.) were used. As the cellulose fibers (B), 0.75 kg in terms of solid content of cellulose nanofibers (manufactured by DAICEL FINECHEM LTD.) was used. For the cellulose nanofibers, 3.75 kg of dispersion liquid (Celish FD-200L, manufactured by DAICEL FINECHEM LTD.) of cellulose nanofibers:water=20:80 (weight ratio) was used. In this preparation example, the cellulose derivative (C) was not used. More specifically, the components were mixed in such a manner that the weight ratio of the cellulose fibers (B) to the entire support material particles was 15.0%.

A dispersion liquid in which the water-soluble base material (A) and the cellulose fibers (B) were dissolved or dispersed in 17.0 kg of water was prepared, and then powder was produced by a spray drying method using a spray drying device. By classifying the obtained powder, support material powder 5 with an average particle diameter of 25 μm was obtained.

### Preparation Example 6

As the water-soluble base material (A), 2.83 kg of maltotetraose (NISSHOKU FUJI OLIGO#450, manufactured by NIHON SHOKUHIN KAKO CO., LTD) and 1.21 kg of lactitol anhydride LC-0 (manufactured by B Food Science Co., Ltd.) were used. As the cellulose fibers (B), 0.71 kg in terms of solid content of cellulose nanofibers (manufactured by DAICEL FINECHEM LTD.) was used. For the cellulose nanofibers, 3.56 kg of dispersion liquid (Celish FD-200L, manufactured by DAICEL FINECHEM LTD.) of cellulose nanofibers:water=20:80 (weight ratio) was used. As the cellulose derivative (C), 0.25 kg of sodium carboxymethylcellulose (CMC Daicel 1220, manufactured by DAICEL FINECHEM LTD.) was used. More specifically, the components were mixed in such a manner that the weight ratio of the cellulose fibers (B) and the weight ratio of the cellulose derivative (C) to the entire support material particles were 15.0% and 5.0%, respectively.

A dispersion liquid in which the water-soluble base material (A), the cellulose fibers (B), and the cellulose derivative (C) were dissolved or dispersed in 17.0 kg of water was prepared, and then powder was produced by a spray drying method using a spray drying device. By classifying the obtained powder, support material powder 6 with an average particle diameter of 25 μm was obtained.

### Preparation Example 7

As the water-soluble base material (A), 2.68 kg of maltotetraose (NISSHOKU FUJI OLIGO#450, manufactured by NIHON SHOKUHIN KAKO CO., LTD) and 1.15 kg of lactitol anhydride LC-0 (manufactured by B Food Science Co., Ltd.) were used. As the cellulose fibers (B), 0.68 kg in terms of solid content of cellulose nanofibers (manufactured by DAICEL FINECHEM LTD.) was used. For the cellulose nanofibers, 3.38 kg of dispersion liquid (Celish FD-200L, manufactured by DAICEL FINECHEM LTD.) of cellulose nanofibers:water=20:80 (weight ratio) was used. As the cellulose derivative (C), 0.50 kg of sodium carboxymethylcellulose (CMC Daicel 1220, manufactured by DAICEL FINECHEM LTD.) was used. More specifically, the components were mixed in such a manner that the weight ratio of the cellulose fibers (B) and the weight ratio of the cellulose derivative (C) to the entire support material particles were 15.0% and 10.0%, respectively.

A dispersion liquid in which the water-soluble base material (A), the cellulose fibers (B), and the cellulose derivative (C) were dissolved or dispersed in 17.0 kg of water was prepared, and then powder was produced by a spray drying method using a spray drying device. By classifying the obtained powder, support material powder 7 with an average particle diameter of 25 μm was obtained.

### Preparation Example 8

As the water-soluble base material (A), 2.38 kg of maltotetraose (NISSHOKU FUJI OLIGO#450, manufactured by NIHON SHOKUHIN KAKO CO., LTD) and 1.02 kg of lactitol anhydride LC-0 (manufactured by B Food Science Co., Ltd.) were used. As the cellulose fibers (B), 0.60 kg in terms of solid content of cellulose nanofibers (manufactured by DAICEL FINECHEM LTD.) was used. For the cellulose nanofibers, 3.00 kg of dispersion liquid (Celish FD-200L, manufactured by DAICEL FINECHEM LTD.) of cellulose nanofibers:water=20:80 (weight ratio) was used. As the cellulose derivative (C), 1.00 kg of sodium carboxymethylcellulose (CMC Daicel 1220, manufactured by DAICEL FINECHEM LTD.) was used. More specifically, the components were mixed in such a manner that the weight ratio of the cellulose fibers (B) and the weight ratio of the cellulose derivative (C) to the entire support material particles were 15.0% and 20.0%, respectively.

A dispersion liquid in which the water-soluble base material (A), the cellulose fibers (B), and the cellulose derivative (C) were dissolved or dispersed in 17.0 kg of water was prepared, and then powder was produced by a spray drying method using a spray drying device. By classifying the obtained powder, support material powder 8 with an average particle diameter of 25 μm was obtained.

### Preparation Example 9

As the water-soluble base material (A), 2.95 kg of maltotetraose (NISSHOKU FUJI OLIGO#450, manufactured by NIHON SHOKUHIN KAKO CO., LTD) and 1.26 kg of lactitol anhydride LC-0 (manufactured by B Food Science Co., Ltd.) were used. As the cellulose fibers (B), 0.742 kg in terms of solid content of cellulose nanofibers (manufactured by DAICEL FINECHEM LTD.) was used. For the cellulose nanofibers, 3.71 kg of dispersion liquid (Celish FD-200L, manufactured by DAICEL FINECHEM LTD.) of cellulose nanofibers:water=20:80 (weight ratio) was used. As the cellulose derivative (C), 0.05 kg of hydroxyethylcellulose (HEC Daicel SP200, manufactured by DAICEL FINECHEM LTD.) was used. More specifically, the components were mixed in such a manner that the weight ratio of the cellulose fibers (B) and the weight ratio of the cellulose derivative (C) to the entire support material particles were 15.0% and 1.0%, respectively.

A dispersion liquid in which the water-soluble base material (A), the cellulose fibers (B), and the cellulose derivative (C) were dissolved or dispersed in 17.0 kg of water was prepared, and then powder was produced by a spray drying method using a spray drying device. By classifying the obtained powder, support material powder 9 with an average particle diameter of 25 μm was obtained.

### Evaluation of Removability of Support Portion

### Example 1

About 0.05 g of the support material powder 1 prepared in Preparation Example 1 was charged into a mold for forming cylindrical pellets 8 mm in diameter. Then, the mold was warmed to 120° C. with an electric heater while applying a 0.1 MPa load with a pressurization press device (manufactured by MASADA, SEISAKUSHO CO., LTD., MASADA JACK MH-10) to obtain cylindrical pellets (8 mm in diameter and 1 mm in thickness).

The obtained pellets were charged into a 100 mL beaker containing about 50 mL of distilled water as a support removing liquid, and then the pellets were dipped in the support removing liquid. The beaker was placed on a hot plate of a magnetic stirrer body (hot stirrer REMIX RSH-4DN, manufactured by As One Corporation). The support removing liquid in the beaker was warmed to about 60° C. by the hot plate. A magnetic stirrer rotator of 15 mm in length×Φ5 mm was charged into the beaker, and then stirring at about 500 rotations/sec was performed. A seat was disposed in the beaker in such a manner that the pellets do not contact the magnetic stirrer rotator, and then the pellets were disposed on the seat.

The time (removal time) until the pellets collapsed in the state where the pellets were dipped in the support removing liquid, and the shape was lost with visual observation was measured, and then the removability was evaluated according to the following criteria. The results are shown in Table.

Rank A Removal time is less than 3 hours.
Rank B Removal time is 3 hours or more and less than 6 hours.
Rank C Removal time is 6 hours or more.

In Table, “CMCNa” indicates “sodium carboxymethylcellulose” and “HEC” indicates “hydroxyethylcellulose”.

### Example 2

The support material powder 2 prepared in Preparation Example 2 was evaluated for removability in the same manner as in Example 1. The results are shown in Table.

### Example 3

The support material powder 3 prepared in Preparation Example 3 was evaluated for removability in the same manner as in Example 1. The results are shown in Table.

### Example 4

The support material powder 6 prepared in Preparation Example 6 was evaluated for removability in the same manner as in Example 1. The results are shown in Table.

### Example 5

The support material powder 7 prepared in Preparation Example 7 was evaluated for removability in the same manner as in Example 1. The results are shown in Table.

### Example 6

The support material powder 8 prepared in Preparation Example 8 was evaluated for removability in the same manner as in Example 1. The results are shown in Table.

### Example 7

The support material powder 9 prepared in Preparation Example 9 was evaluated for removability in the same manner as in Example 1. The results are shown in Table.

### Comparative Example 1

The support material powder 4 prepared in Preparation Example 4 was evaluated for removability in the same manner as in Example 1. The results are shown in Table.

### Comparative Example 2

The support material powder 5 prepared in Preparation Example 5 was evaluated for removability in the same manner as in Example 1. The results are shown in Table.

### Comparative Example 3

For the support material powder 5 prepared in Preparation Example 5, the support removing liquid in the removal method of Example 1 was changed as follows, and then the removability was evaluated. In place of the distilled water, a removing liquid (0.5 g sodium carboxymethylcellulose was added to 49.5 g of distilled water) in which 1% sodium carboxymethylcellulose was added to distilled water was used. The results are shown in Table.

TABLE

| | Ex. 1 | Ex. 2 | Ex. 3 | Ex. 4 | Ex. 5 |
|---|---|---|---|---|---|
| | Support | Support | Support | Support | Support |
| | material | material | material | material | material |
| | powder 1 | powder 2 | powder 3 | powder 6 | powder 7 |
| Water-soluble base | Maltotetraose | Maltotetraose | Maltotetraose | Maltotetraose | Maltotetraose |
| material (A) | Lactitol | Lactitol | Lactitol | Lactitol | Lactitol |
| Non-water-soluble | Cellulose | Cellulose | Cellulose | Cellulose | Cellulose |
| cellulose fiber (B) | nanofibers | nanofibers | nanofibers | nanofibers | nanofibers |
| % by mass | 14.9% | 15.0% | 15.0% | 15.0% | 15.0% |
| Water-solube | CMCNa | CMCNa | CMCNa | CMCNa | CMCNa |
| cellulose derivative (C) | | | | | |
| % by mass | 1.00% | 0.10% | 0.05% | 5.00% | 10.00% |
| Support removing | Water | Water | Water | Water | Water |
| liquid | — | — | — | — | — |
| Removability | A | A | B | A | A |
| | Ex. 6 | Ex. 7 | Comp. Ex. 1 | Comp. Ex. 2 | Comp. Ex. 3 |
| | Support | Support | Support | Support | Support |
| | material | material | material | material | material |
| | powder 8 | powder 9 | powder 4 | powder 5 | powder 5 |
| Water-soluble base | Maltotetraose | Maltotetraose | Maltotetraose | Maltotetraose | Maltotetraose |
| material (A) | Lactitol | Lactitol | Lactitol | Lactitol | Lactitol |
| Non-water-soluble | Cellulose | Cellulose | Cellulose | Cellulose | Cellulose |
| cellulose fiber (B) | nanofibers | nanofibers | nanofibers | nanofibers | nanofibers |
| % by mass | 15.0% | 15.0% | 15.0% | 15.0% | 15.0% |
| Water-solube | CMCNa | HEC | CMCNa | — | — |
| cellulose derivative (C) | | | | | |
| % by mass | 20.00% | 1.00% | 0.01% | — | — |
| Support removing | Water | Water | Water | Water | Water |
| liquid | — | — | — | — | CMCNa |
| Removability | B | B | C | C | C |

In Examples 1, 2, 4, and 5, the pellets formed using the support material powder were able to be removed in less than 3 hours. When the pellet surface was observed after several minutes passed after the pellets were dipped in the support removing liquid, it was not confirmed that a gel-like barrier layer was formed on the surface of the pellets.

In Examples 3, 6, and 7, the pellets formed using the support material powder were able to be removed in 3 hours or more and less than 6 hours. When the pellet surface was observed after several minutes passed after the pellets were dipped in the support removing liquid, it was confirmed that a gel-like barrier layer was partially formed on the surface of the pellets of Example 3. In Example 3, it was presumed that, due to the barrier layer, the removal speed decreased and the removability decreased as compared with other Examples.

In Comparative Examples 1 to 3, the pellets formed using the support material powder were not able to be removed even when 6 hours passed.

In Comparative Examples 1 and 2, when the pellet surface was observed after several minutes passed after the pellets were dipped in the support removing liquid, it was confirmed that a gel-like barrier layer was firmly formed on the surface of the pellets. When the barrier layer was physically scratched using a spatula after finishing the evaluation of the removability, the dissolution advanced.

When the cellulose derivative (C) was compounded not in the support material but in the support removing liquid as in Comparative Example 3, the removability of the support material did not improve. Also in Comparative Example 3, when the pellet surface was observed after several minutes passed after the pellets were dipped in the support removing liquid, it was confirmed that a gel-like barrier layer was firmly formed on the surface of the pellets.

In Examples, since the cellulose derivative (C) was compounded in the support material, the cellulose derivative was compounded in the support portion. It is considered that, when the support portion was brought into contact with the support removing liquid in this state, so that the cellulose fibers (B) were dispersed in the support removing liquid, the cellulose derivative (C) surrounded the cellulose fibers (B) as much as possible before the cellulose fibers (B) firmly aggregated or gelled, and thus the aggregation can be prevented. Therefore, it is presumed that the support portion was able to be easily removed without the formation of a firm barrier layer by the cellulose fibers (B).

Therefore, it is presumed that the support portion was able to be easily removed without the formation of a firm barrier layer by the cellulose fibers (B).

On the other hand, it is considered that, when the cellulose derivative (C) was compounded only in the support removing liquid as in Comparative Example 3, the cellulose fibers (B) firmly aggregated or gelled before the cellulose derivative (C) surrounded the cellulose fibers (B). Therefore, it is presumed that a firm barrier layer by the cellulose fibers (B) was formed, and therefore the support portion was not able to be efficiently removed.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-072982 filed Mar. 31, 2016 and No. 2017-039655 filed Mar. 2, 2017, which are hereby incorporated by reference herein in their entirety.

What is claimed is:

1. A support material comprising:
at least one member selected from the group consisting of low molecular weight saccharides, polyvinyl alcohols, and polyalkylene glycols;
non-water-soluble cellulose fibers; and
a water-soluble cellulose derivative.

2. The support material according to claim 1, wherein the water-soluble cellulose derivative is an anionic cellulose derivative.

3. The support material according to claim 1, wherein the water-soluble cellulose derivative is a carboxymethylcellulose salt.

4. The support material according to claim 1, wherein the water-soluble cellulose derivative is a nonionic cellulose derivative.

5. The support material according to claim 1, wherein the water-soluble cellulose derivative is hydroxypropylcellulose.

6. The support material according to claim 1, wherein a content of the water-soluble cellulose derivative is 0.05% by mass or more and 20% by mass or less of the total mass of the support material.

7. The support material according to claim 1, wherein the content of the water-soluble cellulose derivative is 0.3% by mass or more and 70% by mass or less of the total mass of the non-water-soluble cellulose fibers.

8. The support material according to claim 1, wherein a total content of the low molecular weight saccharides, the polyvinyl alcohols, and the polyalkylene glycols is 50% by mass or more and 95% by mass or less of the total mass of the support material.

9. The support material according to claim 1, wherein a content of the non-water-soluble cellulose fibers is 10% by mass or more and less than 50% by mass; and
a content of the water-soluble cellulose derivative is 0.05% by mass or more and 20% by mass or less of the total mass of the support material.

10. The support material according to claim 1, wherein the low molecular weight saccharides are saccharides having a molecular weight of 100 or more and 1000 or less.

11. The support material according to claim 1, wherein the low molecular weight saccharides include at least one member selected from the group consisting of monosaccharide, disaccharide, trisaccharide, tetrasaccharide, pentasaccharide, sugar alcohol derived from monosaccharide, sugar alcohol derived from disaccharide, sugar alcohol derived from trisaccharide, sugar alcohol derived from tetrasaccharide, and sugar alcohol derived from pentasaccharide.

12. The support material according to claim 1, wherein the non-water-soluble cellulose fibers have an average fiber diameter of 1 nm or more and 500 nm or less.

13. Support material powder comprising:
a particulate support material, wherein
the support material comprising:
at least one member selected from the group consisting of low molecular weight saccharides, polyvinyl alcohols, and polyalkylene glycols;
non-water-soluble cellulose fibers; and
a water-soluble cellulose derivative.

14. A method for producing a three-dimensional object comprising:
a first step of forming a shaped substance containing a structure portion forming a three-dimensional object and a support portion supporting the structure portion; and
a second step of removing the support portion from the shaped substance by bringing the shaped substance into contact with a liquid containing water to form the three-dimensional object, wherein
in the first step, the support portion is formed using the support material comprising:
at least one member selected from the group consisting of low molecular weight saccharides, polyvinyl alcohols, and polyalkylene glycols;
non-water-soluble cellulose fibers; and
a water-soluble cellulose derivative.
